(19) United States
(12) Patent Application Publication
(10) Pub. No.: US 2019/0377344 A1
(43) Pub. Date: Dec. 12, 2019

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Atsushi Ishioka, Wako-shi (JP); Akihiko Otsu, Wako-shi (JP); Akira Mizutani, Wako-shi (JP); Daichi Kato, Wako-shi (JP); Kazuyuki Takahashi, Wako-shi (JP)

(21) Appl. No.: 16/479,962

(22) PCT Filed: Feb. 3, 2017
(86) PCT No.: PCT/JP2017/003911

§ 371 Date: Jul. 23, 2019

(51) Int. Cl. G05D 1/00; G05D 1/02; G08G 1/0967

(52) U.S. Cl. CPC G05D 1/0088; G05D 2201/0213; G08G 1/0967; G05D 1/0212

(57) ABSTRACT

A vehicle control system includes: a static information acquirer that is configured to acquire static information that is static information relating to gates; a dynamic information acquirer that is configured to acquire dynamic information that is dynamic information relating to the gates; a selector that is configured to select a gate among a plurality of gates on the basis of the static information acquired by the static information acquirer and thereafter correct a selection result of gates on the basis of the dynamic information acquired by the dynamic information acquirer; and a gate passage controller that is configured to perform control of a vehicle such that the vehicle passes through the gate selected by the selector.

### TECHNICAL FIELD

The present invention relates to a vehicle control system, a vehicle control method, and a vehicle control program.

### BACKGROUND ART

Conventionally, a navigation device which processes an image captured by an in-vehicle camera mounted in a vehicle, recognizes gates operating at a tollgate, identifies one gate among the recognized gates, sets a running route from the current position of the vehicle to the identified gate using an aspect of a virtual running lane, and displays the set running route on a running route display is known (for example, see Patent Document 1).

### CITATION LIST

### Patent Literature

[Patent Document 1] Japanese Unexamined Patent Application, First Publication No. 2014-119372

### SUMMARY OF INVENTION

### Technical Problem

In the conventional technology described above, although a shortest running route is set and guidance is provided by identifying an operating gate that is closest to the current position of the vehicle, it cannot be determined that the shortest running route is an optimal running route.

The present invention is in consideration of such situations, and one object thereof is to provide a vehicle control system, a vehicle control method, and a vehicle control program capable of selecting a more preferable gate.

### Solution to Problem

An invention according to claim 1 is a vehicle control system (1 or 100) including: a static information acquirer (123a) that is configured to acquire static information that is static information relating to gates; a dynamic information acquirer (123b) that is configured to acquire dynamic information that is dynamic information relating to the gates; a selector (123c or 123d) that is configured to select a gate among a plurality of gates on the basis of the static information acquired by the static information acquirer and thereafter correct a selection result of gates on the basis of the dynamic information acquired by the dynamic information acquirer; and a gate passage controller (123A) that is configured to perform control of a vehicle such that the vehicle passes through the gate selected by the selector.

An invention according to claim 2 is the vehicle control system according to claim 1, wherein the static information is information acquired before a subject vehicle approaches the gate, and the dynamic information is information acquired when the subject vehicle approaches the gate.

An invention according to claim 3 is the vehicle control system according to claim 2, wherein the information acquired before the subject vehicle approaches the gate includes at least one of a gate structure, a destination of the subject vehicle, and information representing whether or not the gate can be passed using an ETC in-vehicle device, and the information acquired when the subject vehicle approaches the gate includes at least one of information representing whether or not the gate is in a usable state and information representing a congestion degree of the gate.

An invention according to claim 4 is the vehicle control system according to any one of claims 1 to 3, wherein the dynamic information acquirer is configured to repeatedly acquire the dynamic information, and the selector is configured to repeatedly correct the selection result of the gates.

An invention according to claim 5 is a vehicle control system (1 or 100) including: a selector (123c or 123d) that is configured to select a gate among a plurality of gates on the basis of information acquired before approaching a gate and thereafter correct a selection result of the gates on the basis of information acquired at the time of approaching the gates; and a gate passage controller (123A) that is configured to perform control of a vehicle such that the vehicle passes through the gate selected by the selector.

An invention according to claim 6 is the vehicle control system according to any one of claims 1 to 4, wherein the selector corrects the selection result of the gates on the basis of a distance from a position of a subject vehicle to a gate, an arrival target position that is an arrival target in the case of entering the gate, a distance from another vehicle present in the vicinity of the arrival target position, and a relative speed between the other vehicle and the subject vehicle.

An invention according to claim 7 is a vehicle control method using an in-vehicle computer, the vehicle control method including: acquiring static information that is static information relating to gates; acquiring dynamic information that is dynamic information relating to the gates; selecting a gate among a plurality of gates on the basis of the static information acquired by the static information acquirer; thereafter correcting a selection result of gates on the basis of the dynamic information acquired by the dynamic information acquirer; and performing control of a vehicle such that the vehicle passes through the gate selected by the selector.

An invention according to claim 8 is a vehicle control program causing an in-vehicle computer to execute: acquiring static information that is static information relating to gates; acquiring dynamic information that is dynamic information relating to the gates; selecting a gate among a plurality of gates on the basis of the static information acquired by the static information acquirer; thereafter correcting a selection result of gates on the basis of the dynamic information acquired by the dynamic information acquirer; and performing control of a vehicle such that the vehicle passes through the gate selected by the selector.

### Advantageous Effects of Invention

According to the inventions described in claims 1 to 3, 5, 7, and 8, the vehicle control system corrects a gate, which has been selected on the basis of static information, on the basis of dynamic information, whereby a preferable gate can be selected.

According to the invention described in claim 4, the vehicle control system is configured to repeatedly correct the selection result of the gates on the basis of dynamic information, whereby a preferable gate can be selected even in a case in which a surrounding situation of the subject vehicle changes.

According to the invention described in claim 6, the selector selects a gate on the basis of a distance from a position of a subject vehicle to a gate, a distance between an arrival target position that is an arrival target in the case of entering the gate and another vehicle present in the vicinity of the arrival target position, and a relative speed between the other vehicle and the subject vehicle, whereby a gate through which the subject vehicle can actually pass can be selected.

### BRIEF DESCRIPTION OF DRAWINGS

FIG. 1 is a configuration diagram of a vehicle system 1 including an automated driving control unit 100.

FIG. 2 is a diagram showing a view in which a relative position and a posture of a subject vehicle M with respect to a running lane L1 are recognized by a subject vehicle position recognizer 122.

FIG. 3 is a diagram showing a view in which a target locus is generated on the basis of a recommended lane.

FIG. 4 is a functional configuration diagram of a gate passage controller 123A.

FIG. 5 is a diagram showing static information and dynamic information.

FIG. 6 is a flowchart showing the flow of a process executed by the gate passage controller 123A.

FIG. 7 is a diagram showing one example of a behavior of a subject vehicle M at the time of passing through a tollgate.

FIG. 8 is a diagram showing one example of a static score.

FIG. 9 is a diagram showing one example of a dynamic score.

FIG. 10 is a diagram showing one example of a view in which a selected gate is corrected.

FIG. 11 is a diagram showing one example of a score at a time t+2.

### DESCRIPTION OF EMBODIMENTS

Hereinafter, a vehicle control system, a vehicle control method, and a vehicle control program according to embodiments of the present invention will be described with reference to the drawings.

### [Entire Configuration]

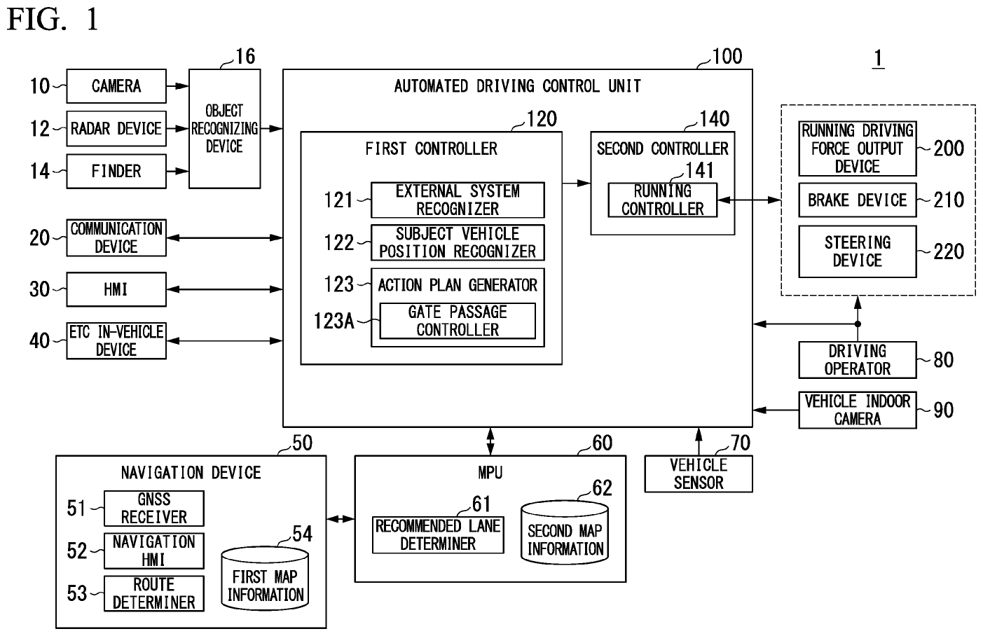

FIG. 1 is a configuration diagram of a vehicle system 1 including an automated driving control unit 100. A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. An electric motor operates using power generated using a power generator connected to an internal combustion engine or discharge power of a secondary cell or a fuel cell.

The vehicle system 1, for example, includes a camera 10, a radar device 12, a finder 14, an object recognizing device 16, a communication device 20, a human machine interface (HMI) 30, an electronic toll collection system (ETC) in-vehicle device 40, a navigation device 50, a micro-processing unit (MPU) 60, a vehicle sensor 70, a driving operator 80, a vehicle indoor camera 90, an automated driving control unit 100, a running driving force output device 200, a brake device 210, and a steering device 220. Such devices and units are interconnected using a multiplex communication line such as a controller area network (CAN) communication line, a serial communication line, a radio communication network, or the like. In addition, the configuration shown in FIG. 1 is merely one example, and thus, some components may be omitted, and, furthermore, another component may be added thereto.

The camera 10, for example, is a digital camera using a solid-state imaging device such as a charge coupled device (CCD) or a complementary metal oxide semiconductor (CMOS). One or a plurality of cameras 10 are installed at arbitrary places in a vehicle (hereinafter, referred to as a subject vehicle M) in which the vehicle system 1 is mounted. In a case in which the side in front is to be imaged, the camera 10 is installed at an upper part of a front windshield, a rear face of a rear-view mirror, or the like. The camera 10, for example, repeatedly images the vicinity of the subject vehicle M periodically. The camera 10 may be a stereo camera.

The radar device 12 emits radiowaves such as millimeter waves to the vicinity of the subject vehicle M and detects at least a position (a distance and an azimuth) of an object by detecting radiowaves (reflected waves) reflected by the object. One or a plurality of radar devices 12 are installed at arbitrary places in the subject vehicle M. The radar device 12 may detect a position and a speed of an object using a frequency modulated continuous wave (FM-CW) system.

The finder 14 is a light detection and ranging or a laser imaging detection and ranging (LIDAR) finder that detects a distance to a target by measuring light scattered from emitted light. One or a plurality of finders 14 are installed at arbitrary places in the subject vehicle M.

The object recognizing device 16 may perform a sensor fusion process on results of detection using some or all of the camera 10, the radar device 12, and the finder 14, thereby recognizing a position, a type, a speed, and the like of an object. The object recognizing device 16 outputs a result of recognition to the automated driving control unit 100.

The communication device 20, for example, communicates with other vehicles present in the vicinity of the subject vehicle M using a cellular network, a Wi-Fi network, Bluetooth (registered trademark), dedicated short range communication (DSRC), or the like or communicates with various server apparatuses through a radio base station.

The HMI 30 presents various types of information to a vehicle occupant of the subject vehicle M and receives an input operation performed by a vehicle occupant. The HMI 30 includes various display devices, a speaker, a buzzer, a touch panel, a switch, a key, and the like.

The ETC in-vehicle device 40 exchanges information of an entrance tollgate, an exit tollgate, and the like by communicating with an ETC road-side device. The ETC in-vehicle device 40 includes a mounter in which an ETC card is mounted, a detector that detects whether or not an ETC card has been mounted in the mounter, a radio communicator that communicates with an ETC road-side device disposed at a gate of a toll road, a notifier, and an ETC controller. The ETC card is a medium in which authentication information (AI) used for the subject vehicle M to pass through a toll road is stored. The radio communicator may be configured to be common with the communication device 20.

The mounter includes an insertion/pulling-out mechanism capable of mounting and pulling out an ETC card. One of a state in which an ETC card is mounted and a state in which an ETC card is pulled out in the mounter is detected by the detector. The detector outputs a result of detection to the automated driving control unit 100 on the basis of control executed by the ETC controller. In addition, the detector may include a functional unit that detects validity or invalidity of an ETC card based on the term of validity and the like of the ETC card. In such a case, the detector may determine a state in which an ETC card is mounted in a case in which the ETC card is valid and determine a state in which no ETC card is mounted in a case in which the ETC card is invalid.

The radio communicator transmits authentication information stored in the ETC card to the ETC road-side device on the basis of control executed by the ETC controller. The radio communicator acquires information of passage/no-passage through a gate in which an ETC road-side device is disposed and an entrance tollgate, an exit tollgate, and the like on the basis of a result of authentication received from the ETC road-side device. The ETC road-side device determines an amount of charge for a vehicle occupant of the subject vehicle M on the basis of the information received from the ETC in-vehicle device and progresses a billing process.

The notifier is a speaker that outputs a voice, an indicator, or the like. The notifier notifies the vehicle occupant of a mounting state of an ETC card and a result of the authentication acquired by the radio communicator.

The navigation device 50, for example, includes a global navigation satellite system (GNSS) receiver 51, a navigation HMI 52, and a route determiner 53 and stores first map information 54 in a storage device such as a hard disk drive (HDD) or a flash memory. The GNSS receiver identifies a position of the subject vehicle M on the basis of signals received from GNSS satellites. The position of the subject vehicle M may be identified or complemented by an inertial navigation system (INS) using an output of the vehicle sensor 70. The navigation HMI 52 includes a display device, a speaker, a touch panel, a key, and the like. A part or the whole of the navigation HMI 52 and the HMI 30 described above may be configured to be shared. The route determiner 53, for example, determines a route from a location of the subject vehicle M identified by the GNSS receiver 51 (or an input arbitrary location) to a destination input by a vehicle occupant using the navigation HMI 52 by referring to the first map information 54. The first map information 54, for example, is information in which a road form is represented by respective links representing a road and respective nodes connected using the links. The first map information 54 may include a curvature of each road, point of interest (POI) information, and the like. The route determined by the route determiner 53 is output to the MPU 60. In addition, the navigation device 50 may perform route guidance using the navigation HMI 52 on the basis of the route determined by the route determiner 53. Furthermore, the navigation device 50, for example, may be implemented by a function of a terminal device such as a smartphone or a tablet terminal carried by a user. In addition, the navigation device 50 may transmit a current location and a destination to a navigation server through the communication device 20 and acquire a route received from the navigation server as a reply.

The MPU 60, for example, functions as a recommended lane determiner 61 and maintains second map information 62 in a storage device such as an HDD or a flash memory. The recommended lane determiner 61 divides a route provided from the navigation device 50 into a plurality of blocks (for example, divides the route into blocks of 100 m in the advancement direction of the vehicle) and determines a target lane for each block by referring to the second map information 62. The recommended lane determiner 61 determines which lane to run from the left side. In a case in which a branching place, a merging place, or the like is present in the route, the recommended lane determiner 61 determines a recommended lane such that the subject vehicle M can run on a reasonable route for advancement to divergent destinations.

The second map information 62 is map information having an accuracy higher than that of the first map information 54. The second map information 62, for example, includes information of the center of respective lanes, information on boundaries between lanes, or the like. In addition, in the second map information 62, road information, traffic regulations information, address information (address and zip code), facilities information, telephone information, and the like may be included. In the road information, information representing a type of road such as an expressway, a toll road, a national highway, or a prefectural road and information such as the number of lanes of a road, a width of each lane, a gradient of a road, a position of a road (three-dimensional coordinates including longitude, latitude, and a height), a curvature of the curve of a lane, locations of merging and branching points of lanes, a sign installed on a road, and the like are included. The second map information 62 may be updated as is necessary by accessing another device using the communication device 20.

In addition, in the second map information 62, information representing a gate structure such as an entrance tollgate, an exit tollgate, and the like is stored. The information representing a gate structure, for example, is information representing the number of gates disposed at the tollgate and the positions of the gates and information representing types of the gate (information such as an ETC-dedicated gate, a general gate, and the like).

The vehicle sensor 70 includes a vehicle speed sensor detecting a speed of the subject vehicle M, an acceleration sensor detecting an acceleration, a yaw rate sensor detecting an angular velocity around a vertical axis, an azimuth sensor detecting the azimuth of the subject vehicle M, and the like.

The driving operator 80, for example, includes an acceleration pedal, a brake pedal, a shift lever, a steering wheel, and other operators. A sensor detecting the amount of an operation or the presence/absence of an operation is installed in the driving operator 80, and a result of the detection is output to one or both of the automated driving control unit 100 and the running driving force output device 200, the brake device 210, or the steering device 220.

The vehicle indoor camera 90 images an upper body half by focusing on the face of a vehicle occupant sitting on a driver seat. An image captured by the vehicle indoor camera 90 is output to the automated driving control unit 100.

The automated driving control unit 100, for example, includes a first controller 120 and a second controller 140. Each of the first controller 120 and the second controller 140 is implemented by a processor such as a central processing unit (CPU) executing a program (software). In addition, some or all of the functional units may be implemented by hardware such as a large scale integration (LSI), an application specific integrated circuit (ASIC), a field-programmable gate array (FPGA), or the like or may be implemented by cooperation between software and hardware.

The first controller 120, for example, includes the external system recognizer 121, the subject vehicle position recognizer 122, and an action plan generator 123.

The external system recognizer 121 recognizes states of surrounding vehicles such as positions, speeds, and accelerations on the basis of information input from the camera 10, the radar device 12, and the finder 14 through the object recognizing device 16. The position of a surrounding vehicle may be represented as a representative point of the surrounding vehicle such as the center of gravity, a corner, or the like and may be represented by an area represented by the contour of the surrounding vehicle. The “state” of a surrounding vehicle may include an acceleration or a jerk or may be an “action state” (for example, the vehicle is changing lanes or is to change lanes) of the surrounding vehicle. In addition, the external system recognizer 121 may recognize positions of a guard rail and a telegraph pole, a parked vehicle, a pedestrian, and other objects in addition to the surrounding vehicles.

The subject vehicle position recognizer 122, for example, recognizes a lane (running lane) in which the subject vehicle M is running and a relative position and a posture of the subject vehicle M with respect to the running lane. The subject vehicle position recognizer 122, for example, by comparing a pattern (for example, an array of solid lines and broken lines) of a road partition line that is acquired from the second map information 62 with a pattern of the road partition line in the vicinity of the subject vehicle M that is recognized from an image captured by the camera 10, recognizes a running lane. In the recognition, the position of the subject vehicle M acquired from the navigation device 50 and a processing result acquired using the INS may be taken into account.

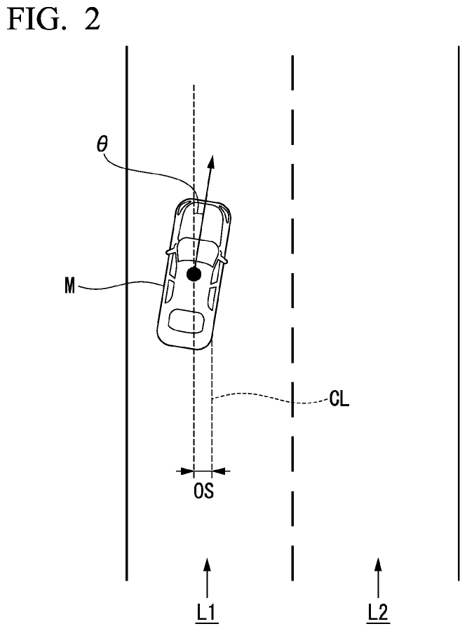

Then, the subject vehicle position recognizer 122, for example, recognizes a position and a posture of the subject vehicle M with respect to the running lane. FIG. 2 is a diagram showing a view in which a relative position and a posture of a subject vehicle M with respect to a running lane L1 are recognized by the subject vehicle position recognizer 122. The subject vehicle position recognizer 122, for example, recognizes an offset OS of a reference point (for example, center of gravity) of the subject vehicle M from running lane center CL and an angle θ of an advancement direction of the subject vehicle M formed with respect to a line acquired by aligning the running lane center CL as a relative position and a posture of the subject vehicle M with respect to the running lane L1. In addition, instead of this, the subject vehicle position recognizer 122 may recognize a position of the reference point of the subject vehicle M with respect to one side end of its own lane L1 or the like as a relative position of the subject vehicle M with respect to the running lane. The relative position of the subject vehicle M recognized by the subject vehicle position recognizer 122 is provided for the recommended lane determiner 61 and the action plan generator 123.

The action plan generator 123 determines events to be sequentially executed in automated driving such that the subject vehicle M runs in a recommended lane determined by the recommended lane determiner 61 and deals with to a surrounding status of the subject vehicle M. As the events, for example, there are a constant-speed running event in which the subject vehicle runs at a constant speed in the same running lane, a following running event in which the subject vehicle follows a vehicle running ahead, a lane changing event, a merging event, a branching event, an emergency stop event, a handover event for ending automated driving and switching to manual driving, a tollgate event executed in the case of passing through a tollgate (to be described later), and the like. In addition, during the execution of such an event, there are cases in which an action for avoidance is planned on the basis of surrounding statuses of the subject vehicle M (the presence/absence of surrounding vehicles and pedestrians, lane contraction according to road constriction, and the like).

The action plan generator 123 generates a target locus in which the subject vehicle M will run in the future. The target locus, for example, includes a speed factor. For example, a plurality of reference times in the future may be set for every predetermined sampling time (for example, a fraction of a [sec]), and the target locus is generated as a set of target positions (locus points) that the subject vehicle is to reach at such reference times. For this reason, in a case in which a gap between locus points is large, this represents high-speed running in a section between the locus points.

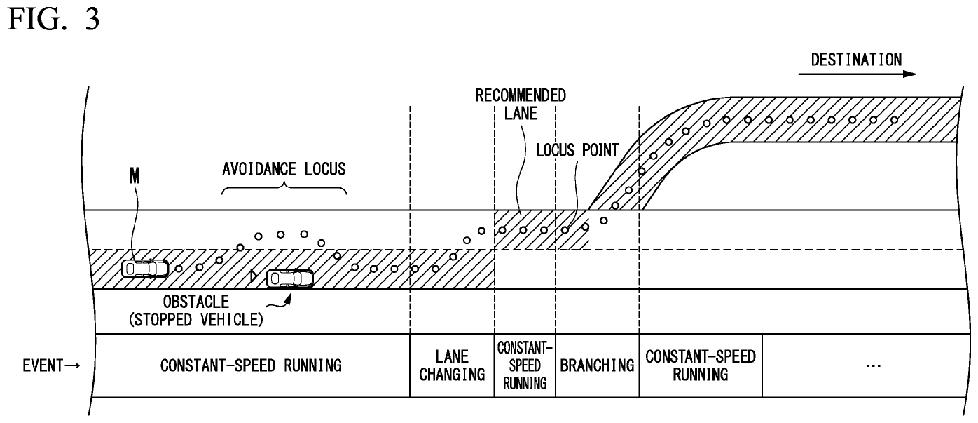

FIG. 3 is a diagram showing a view in which a target locus is generated on the basis of a recommended lane. As shown in the drawing, the recommended lane is set such that it is convenient for the subject vehicle to run along a route to a destination. When the subject vehicle reaches a position before a predetermined distance from a switching point of a recommended lane switching place (may be determined in accordance with a type of event), the action plan generator 123 starts the lane changing event, the branching event, the merging event, or the like. In a case in which there is a need for avoiding an obstacle during the execution of each event, as shown in the drawing, an avoidance locus is generated.

In addition, the action plan generator 123 generates a plurality of candidates of a target locus and selects a target locus that is optimal at that time point on the basis of the viewpoints of safety and efficiency.

The action plan generator 123, for example, includes a gate passage controller 123A as a sub-function. Details of the gate passage controller 123A will be described later.

The second controller 140 includes a running controller 141. The running controller 141 controls the running driving force output device 200, the brake device 210, and the steering device 220 such that the subject vehicle M passes through a target locus generated by the action plan generator 123 at a scheduled time.

The running driving force output device 200 outputs a running driving force (torque) for allowing a vehicle to run to driving wheels. The running driving force output device 200, for example, includes a combination of an internal combustion engine, an electric motor, a transmission gear, and the like and an ECU controlling such components. The ECU controls the components described above on the basis of information input from the running controller 141 or information input from the driving operator 80.

The brake device 210, for example, includes a brake caliper, a cylinder delivering hydraulic pressure to the brake caliper, an electric motor generating hydraulic pressure in the cylinder, and a brake ECU. The brake ECU controls the electric motor on the basis of the information input from the running controller 141 or the information input from the driving operator 80 such that a brake torque associated with a braking operation is output to each vehicle wheel. The brake device 210 may include a mechanism that delivers a hydraulic pressure generated in accordance with an operation for a brake pedal included in the driving operator 80 to the cylinder through a master cylinder as a backup. In addition, the brake device 210 is not limited to the configuration described above and may be an electronic control-type hydraulic brake device that delivers a hydraulic pressure of the master cylinder to the cylinder by controlling an actuator on the basis of information input from the running controller 141.

The steering device 220, for example, includes a steering ECU and an electric motor. The electric motor, for example, changes the direction of the steering wheel by applying a force to a rack and pinion mechanism. The steering ECU changes the direction of the steering wheel by driving the electric motor in accordance with information input from the running controller 141 or information input from the driving operator 80.

### [Details of Gate Passage Controller]

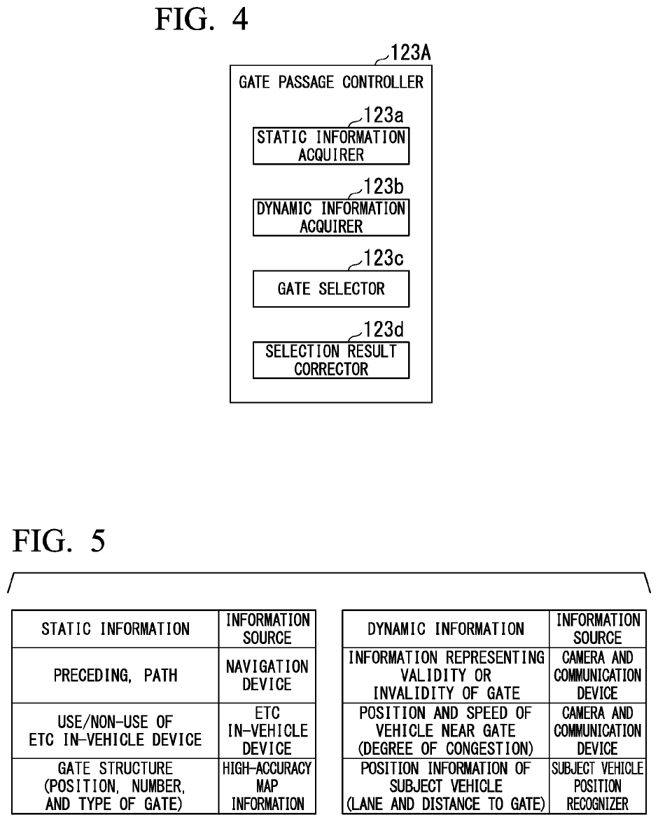

The gate passage controller 123A selects a gate through which a vehicle passes and controls the vehicle such that it passes through the selected gate. FIG. 4 is a functional configuration diagram of the gate passage controller 123A. The gate passage controller 123A includes a static information acquirer 123a, a dynamic information acquirer 123b, a gate selector 123c, and a selection result corrector 123d. A part of the function of the gate passage controller 123A may be executed by the MPU 60. For example, the static information acquirer 123a and the gate selector 123c may be included in the MPU 60.

The static information acquirer 123a acquires static information that is static information relating to a gate. The dynamic information acquirer 123b acquires dynamic information that is dynamic information relating to a gate. FIG. 5 is a diagram showing static information and dynamic information. The static information is information that is acquired before a subject vehicle M approaches a gate, and the dynamic information is information that is acquired when the subject vehicle M approaches a gate. The static information, for example, includes information relating to a destination or a route of the subject vehicle M that is acquired from the navigation device 50, information representing use/non-use of the ETC in-vehicle device that is acquired from the ETC in-vehicle device 40, information representing a gate structure acquired from the high-accuracy map information 62 (positions and numbers of gates and types of the gates), and the like.

The dynamic information, for example, includes information representing validity or invalidity of a gate that is acquired on the basis of a result of an analysis of an image captured using the camera 10, information representing positions and speeds of vehicles near a gate, information representing a degree of congestion of a gate, position information of a subject vehicle M that is recognized by the subject vehicle position recognizer 122, and the like. This position information of the subject vehicle M is information used for deriving a distance from the position of the subject vehicle M to a gate or a road sign near a gate.

In addition, the information representing validity or invalidity of a gate, the information representing positions and speeds of vehicles near a gate, and the information representing the degree of congestion of a gate may be acquired through the communication device 20. The communication device 20, for example, acquires the information representing validity or invalidity of a gate or the information representing positions and speeds of vehicles near a gate from a road-side communication device disposed near the gate. The road-side communication device transmits an image captured using a camera capturing a front area of a gate to the communication device 20. In addition, the communication device 20 may acquire the information representing validity or invalidity of a gate, the information representing positions and speeds of vehicles near a gate, the information representing the degree of congestion of a gate, and the like from a server apparatus or the like connected to a network using radio communication.

In addition, information acquired by the communication device 20 before the subject vehicle M approaches a gate is classified as static information, and information acquired by the communication device 20 when the subject vehicle M approaches a gate is classified as dynamic information. In addition, for example, in a case in which the information representing a type of gate, the information representing validity or invalidity of a gate, the information representing positions and speeds of vehicles near a gate, the degree of congestion in front of a gate, and the like are classified as static information in a case in which such information is information acquired before the subject vehicle M approaches the gate, and information acquired when the subject vehicle M becomes close to a gate is classified as dynamic information.

The gate selector 123c selects a gate from among a plurality of gates on the basis of the static information acquired by the static information acquirer 123b.

The selection result corrector 123d corrects a selection result selected by the gate selector 123c on the basis of the dynamic information acquired by the dynamic information acquirer 123b. The selection result corrector 123d, for example, changes the gate selected by the gate selector 123c to a more appropriate gate on the basis of the dynamic information. The more appropriate gate is a gate through which the subject vehicle M can pass while running more smoothly or a gate of which the degree of congestion is lower than those of the other gates. The gate passage controller 123A controls the subject vehicle M such that it passes through the gate selected by the selection result corrector 123d.

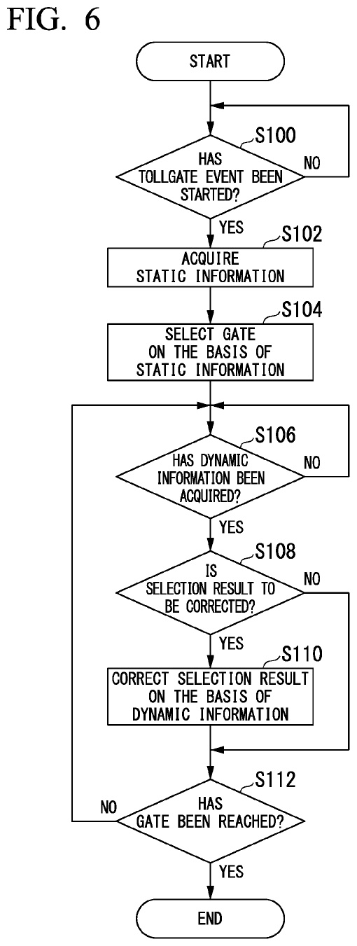

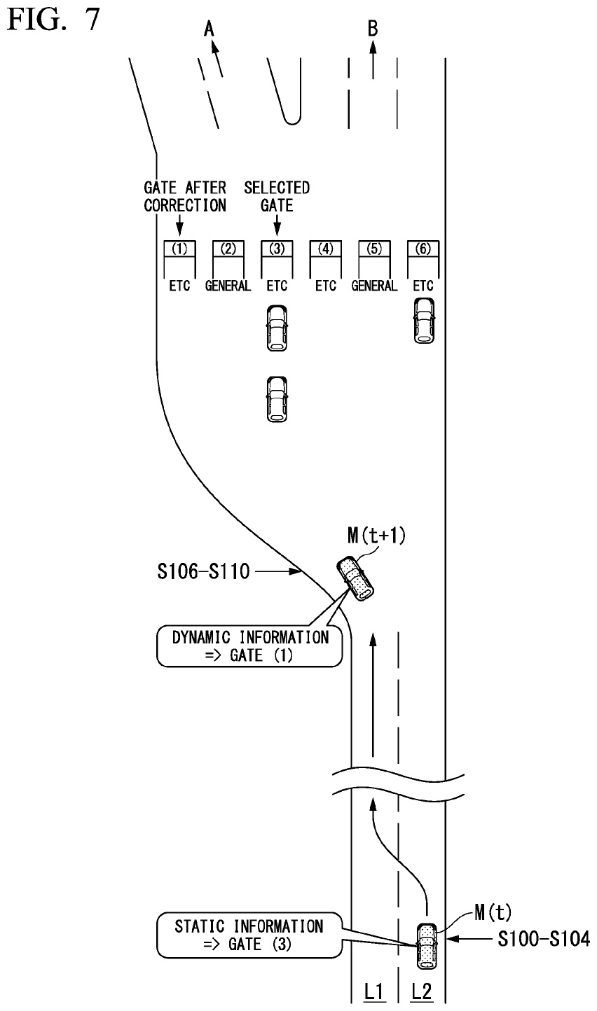

FIG. 6 is a flowchart showing the flow of a process executed by the gate passage controller 123A. A specific behavior of the subject vehicle M will be described with reference to FIG. 7.

First, the gate passage controller 123A determines whether or not a timing at which a tollgate event is started has arrived (Step S100). When the timing at which the tollgate event is started arrives, the static information acquirer 123a acquires static information (Step S102). Next, the gate selector 123c selects a gate through which passage is planned on the basis of the static information acquired in Step S102 (Step S104). In addition, the gate selector 123c may determine a lane in which the subject vehicle M runs on the basis of the destination of the subject vehicle M and select a gate to pass while taking the determined lane into account. Next, the dynamic information acquirer 123b waits until dynamic information can be acquired (Step S106).

When the dynamic information is acquired, the selection result corrector 123d determines whether or not it is necessary to correct the selection result of Step S104 on the basis of the dynamic information acquired in Step S106 (Step S108). In a case in which it is necessary to correct the selection result, the selection result corrector 123d corrects the selection result on the basis of the dynamic information acquired in Step S106 (Step S110), and the process proceeds to the process of Step S112. In a case in which it is not necessary to correct the selection result, the gate passage controller 123A determines whether or not the subject vehicle M has reached a gate (Step S112). In a case in which the subject vehicle has not reached a gate, the process is returned to the process of Step S106. On the other hand, in a case in which the subject vehicle has reached a gate, the process of this flowchart ends.

FIG. 7 is a diagram showing one example of a behavior of the subject vehicle M at the time of passing through a tollgate. In the tollgate shown in the drawing, gates (1) to (6) are disposed, and it is assumed that the gates (1), (3), (4), and (6) are ETC-dedicated gates and gates (2) and (4) are general gates. In addition, it is assumed that a road after passage through a gate branches into a road directed in a direction A and a road directed in a direction B.

At a time t, a destination set in the subject vehicle M is in the direction A, and accordingly, a route in the direction A is set by the navigation device 50. In addition, it is assumed that passage of the subject vehicle M through a gate using the ETC in-vehicle device 40 is planned and that the subject vehicle M is running along a main line L2 in front of gates.

At a time t, when the subject vehicle M reaches a first predetermined distance in front of gates, the gate passage controller 123A starts a tollgate event, and the static information acquirer 123a acquires static information. In this case, the gate selector 123c assigns static scores to the gates on the basis of the static information.

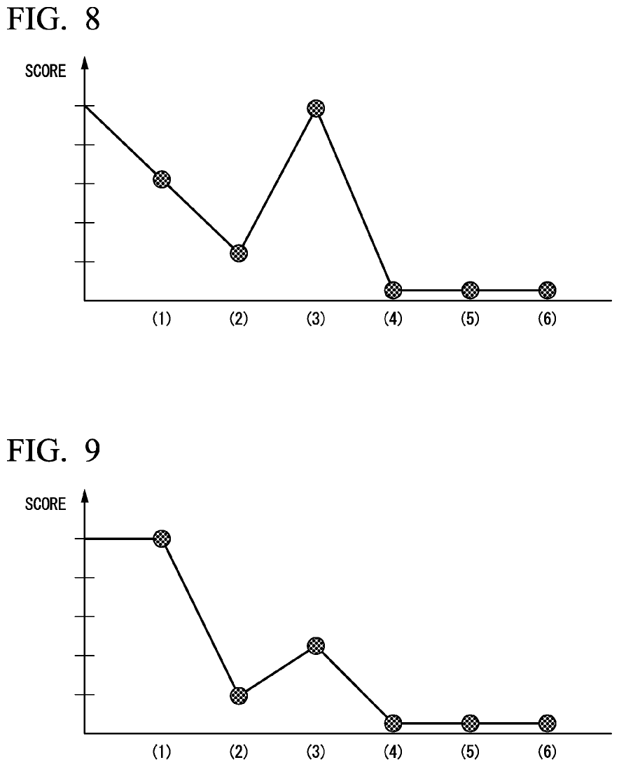

FIG. 8 is a diagram showing one example of static scores. The horizontal axis represents identification information of gates, and the vertical axis represents scores. The gate selector 123c, for example, assigns a static score to each gate from a viewpoint of easy movement to a destination. The gate selector 123c sets a score assigned to a gate (3) to be the highest and sets a score assigned to a gate (1) to be the second highest. The reason for this is that, by causing the subject vehicle to pass through the gate (3), in a case in which the subject vehicle M is directed in the direction A from the current position of the subject vehicle M, a passage path is the shortest, and a change in the behavior of the vehicle is the smallest. In addition, the static score is not limited thereto and may be calculated from a viewpoint of easy movement to a destination, and various techniques may be employed for details of the calculation method thereof. The gate selector 123c selects the gate (3) that is the most efficient for being directed in the direction A as a gate through which passage is planned on the basis of scores assigned to the gates. Then, the gate passage controller 123A changes the lane of the subject vehicle M from a lane L2 to a lane L1 allowing easy passage through the gate (3).

At a time t+1, when the subject vehicle M reaches a second predetermined distance (shorter than the first predetermined distance) in front of gates, the dynamic information acquirer 123b acquires information representing validity or invalidity of each gate, a vehicle state in which a vehicle row is formed toward each gate, a state of a vehicle running toward a gate, a type of gate, and the like as dynamic information. Here, although there are cases in which the type of gate is acquired as static information, there are cases in which the type of gate changes in accordance with a time zone or a traffic condition, and accordingly, the type of gate may be acquired as dynamic information while also being acquired as static information.

The gate selector 123c assigns an integrated score to a gate by adding a dynamic score to a static score on the basis of the dynamic information. FIG. 9 is a diagram showing one example of dynamic scores. The horizontal axis represents identification information of gates, and the vertical axis represents scores. The selection result corrector 123d, for example, assigns a dynamic score to each gate from a viewpoint of lowering the congestion, shortening a time until arrival at the gate, decreasing the number of virtual lane changes, and the like. The selection result corrector 123d sets a score assigned to the gate (1) to be the highest and sets a score assigned to the gate (3) to be the second highest. The reason for this is that a plurality of vehicles are lined up at the gate (3), and no vehicles are lined up at the gate (1), and thus smooth passage through a gate can be achieved by causing the subject vehicle to pass through the gate (1). Then, the selection result corrector 123d corrects the gate through which passage by the subject vehicle M is planned from the gate (3) to the gate (1) on the basis of scores assigned to the gates. In addition, when a vehicle row is formed toward gates, in a case in which scores are assigned to the gates, the selection result corrector 123d may assign a high score to a gate associated with a vehicle row in which movement speed of vehicles included in the vehicle row is high.

In addition, the selection result corrector 123d, for example, may select (correct) a gate to pass by additionally taking a distance from the subject vehicle M to the gate (1), a distance between a running path (arrival target position) in a case in which the gate (1) is passed and a nearby vehicle present (or estimated to be present) in the vicinity of the running path, a relative speed between the surrounding vehicle described above and the subject vehicle M, and the like into account. For example, in a case in which a distance to the gate (1) is sufficiently long, and a distance between the subject vehicle M and a nearby vehicle becomes equal to or longer than a predetermined distance in a case in which a path taken in the case of passing through the gate (1) is taken by the subject vehicle M for running, the selection result corrector 123d determines that the gate (1) can be passed and selects the gate (1) having the highest score as a gate to pass. Then, the gate passage controller 123A generates a target locus to the gate and passes through the gate (1) unless the target locus is inappropriate.

On the other hand, in a case in which a distance from the subject vehicle M to the gate (1) is short or a case in which a nearby vehicle is present within a predetermined distance from a path along which the subject vehicle runs in the case of passing through the gate (1), the selection result corrector 123d determines that the gate (1) is inappropriate as a gate to pass and excludes the gate (1) from gates to pass. In this case, the gate passage controller 123A selects a gate other than the gate (1) (for example, a gate having the highest score after the gate (1)).

Then, the gate passage controller 123A generates a target locus to the gate and controls the subject vehicle M such that it runs along the target locus unless the target locus is inappropriate (for example, unless a steering angle exceeds an allowed range).

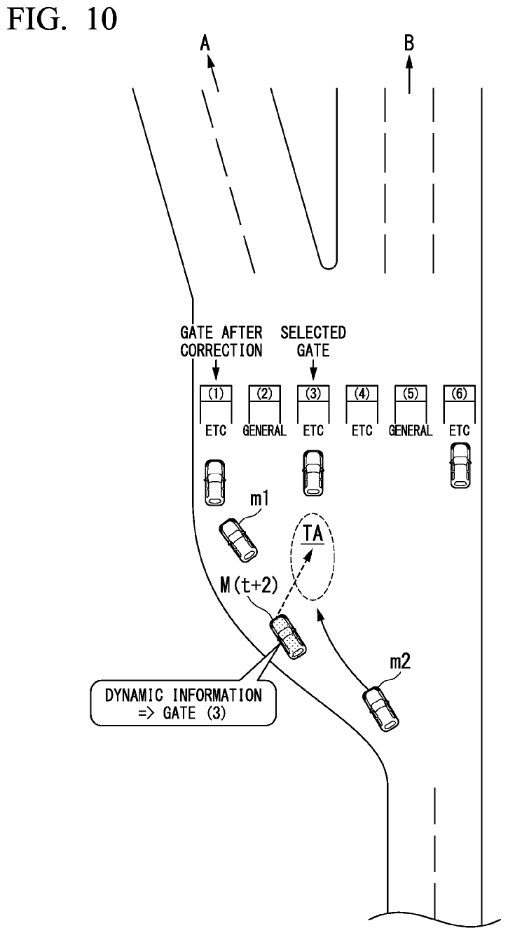

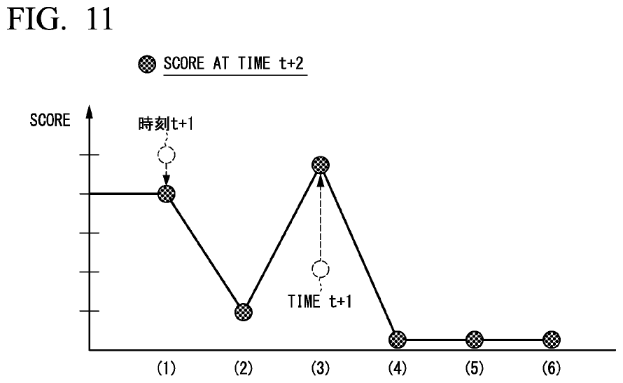

In addition, the selection result corrector 123d repeats the process described above, and corrects a selection result on the basis of the dynamic information and selects a gate. FIG. 10 is a diagram showing one example of a view in which a selected gate is corrected. For example, in a case in which another vehicle m1 directed toward the gate (3) changes its advancement direction such that it is directed toward the gate (1) at a time t+2 (see FIG. 7 for the subject vehicle M at the time t+1), the selection result corrector 123d assigns a score assigned to the gate (1) to be lower than a score assigned at the time t+1 and assigns a score assigned to the gate (3) to be higher than the score assigned at the time t+1. The reason for this is that the vehicle row of the gate (1) becomes long at the gate (1) due to the other vehicle m1 lining up, and the vehicle row of the gate (3) is shortened. FIG. 11 is a diagram showing one example of scores at the time t+2.

Next, the gate passage controller 123A generates a target locus used for entering the gate (3) of which the score becomes high. For example, the gate passage controller 123A moves the subject vehicle M to a target area TA (see FIG. 10) along the target locus.

In this case, for example, the gate passage controller 123A determines whether or not passage through the gate (3) is appropriate with viewpoints of safety and efficiency being taken into account on the basis of a distance between a front end of another vehicle m2 entering the target area TA from the rear side of the target area TA and a rear end of the target area TA, a distance between a rear end of the subject vehicle M and the front end of another vehicle m2, and a distance between the subject vehicle M and the gate (3) (or another vehicle disposed immediately in front of the target area TA). In a case in which it is determined that the passage through the gate (3) is appropriate, the gate passage controller 123A performs control of causing the subject vehicle M to advance to the target area TA and pass through the gate (3). On the other hand, in a case in which it is determined that the passage through the gate (3) is not appropriate, the gate passage controller 123A, for example, controls the subject vehicle M such that it passes through the gate (1) having the highest score after the gate (3).

According to the embodiment described above, the gate selector 123c selects a gate from among a plurality of gates on the basis of static information acquired by the static information acquirer 123a, and thereafter, the selection result corrector 123d corrects a selection result acquired by the gate selector 123c on the basis of dynamic information acquired by the dynamic information acquirer 123b, whereby a preferable gate can be selected.

While forms for performing the present invention has been described using the embodiments, the present invention is not limited to such embodiments at all, and various modifications and substitutions may be made within a range not departing from the concept of the present invention.

### REFERENCE SIGNS LIST

1 vehicle system
10 camera
16 object recognizing device
20 communication device
90 vehicle indoor camera
100 automated driving control unit
120 first controller
121 external system recognizer
122 subject vehicle position recognizer
123 action plan generator
123A gate passage controller
123a static information acquirer
123b dynamic information acquirer
123c gate selector
123d selection result corrector
140 second controller
141 running controller

1.-8. (canceled)

9. A vehicle control system comprising:
a static information acquirer that is configured to acquire static information that is static information relating to gates and is configured to acquire before a subject vehicle approaches the gates;
a dynamic information acquirer that is configured to acquire dynamic information that is dynamic information relating to the gates and is configured to acquire when the subject vehicle approaches the gates;
a selector that is configured to select a gate among a plurality of gates on the basis of the static information acquired by the static information acquirer and thereafter correct a selection result of gates on the basis of the dynamic information acquired by the dynamic information acquirer; and
a gate passage controller that is configured to perform control of a vehicle such that the vehicle passes through the gate selected by the selector.

10. The vehicle control system according to claim 9,
wherein the information acquired before the subject vehicle approaches the gate includes at least one of a gate structure, a destination of the subject vehicle, and information representing whether or not the gate can be passed using an ETC in-vehicle device, and
wherein the information acquired when the subject vehicle approaches the gate includes at least one of information representing whether or not the gate is in a usable state and information representing a congestion degree of the gate.

11. The vehicle control system according to claim 9,
wherein the dynamic information acquirer repeatedly acquires the dynamic information, and
wherein the selector repeatedly corrects the selection result of the gates.

12. The vehicle control system according to claim 10,
wherein the dynamic information acquirer repeatedly acquires the dynamic information, and
wherein the selector repeatedly corrects the selection result of the gates.

13. The vehicle control system according to claim 9, wherein the selector is configured to correct the selection result of the gates on the basis of a distance from a position of a subject vehicle to a gate, a distance between an arrival target position that is an arrival target in the case of entering the gate and other vehicle present in the vicinity of the arrival target position, and a relative speed between the other vehicle and the subject vehicle.

14. The vehicle control system according to claim 10, wherein the selector is configured to correct the selection result of the gates on the basis of a distance from a position of a subject vehicle to a gate, a distance between an arrival target position that is an arrival target in the case of entering the gate and other vehicle present in the vicinity of the arrival target position, and a relative speed between the other vehicle and the subject vehicle.

15. The vehicle control system according to claim 11, wherein the selector is configured to correct the selection result of the gates on the basis of a distance from a position of a subject vehicle to a gate, a distance between an arrival target position that is an arrival target in the case of entering the gate and other vehicle present in the vicinity of the arrival target position, and a relative speed between the other vehicle and the subject vehicle.

16. The vehicle control system according to claim 12, wherein the selector is configured to correct the selection result of the gates on the basis of a distance from a position of a subject vehicle to a gate, a distance between an arrival target position that is an arrival target in the case of entering the gate and other vehicle present in the vicinity of the arrival target position, and a relative speed between the other vehicle and the subject vehicle.

17. A vehicle control system comprising:
a selector that is configured to select a gate among a plurality of gates on the basis of information acquired before approaching a gate and thereafter correct a selection result of the gates on the basis of information acquired at the time of approaching the gates; and
a gate passage controller that is configured to perform control of a vehicle such that the vehicle passes through the gate selected by the selector.

18. A vehicle control method using an in-vehicle computer, the vehicle control method comprising:
acquiring static information that is static information relating to gates and is acquired before a subject vehicle approaches the gates;
acquiring dynamic information that is dynamic information relating to the gates and is acquired when the subject vehicle approaches the gates;
selecting a gate among a plurality of gates on the basis of the static information acquired;
thereafter correcting a selection result of gates on the basis of the dynamic information acquired; and
performing control of a vehicle such that the vehicle passes through the gate selected.
